(19) United States
(12) Patent Application Publication
(10) Pub. No.: US 2007/0263695 A1
(43) Pub. Date: Nov. 15, 2007

(54) Temperature Sensitive Sign

(76) Inventor: Luis Figarella, Nashua, NH (US)

Correspondence Address: LUIS FIGARELLA, 27 TODD ROAD, NASHUA, NH, 03064, US

(21) Appl. No.: 11/308,822

(22) Filed: May 11, 2006

(51) Int. Cl. G01N 25/02

(52) U.S. Cl. 374/16

(57) ABSTRACT

A device that warns when the freezing point of water is at/near. In this fashion, motorists may be alerted to freezing or near freezing conditions near a roadway.

### BACKGROUND OF THE INVENTION

1. Field of the Invention

The present invention generally relates to a device that visually signals the approach and existence of freezing conditions of water to motorists and others.

2. Description of the Related Art

In areas subject to freezing weather, vehicle accidents escalate when the temperature approaches and reaches that of freezing (0° C.) for water on roads and bridges. At this time, water which may have reached and accumulated on the road in a liquid state, may suddenly freeze (totally or partially), causing vehicles to slip and slide. While even seasoned drivers aware of local driving conditions may be surprised during a sudden change, the effects are usually worse on drivers unaccustomed to the conditions. Similarly, pilots may benefit from this knowledge about surface conditions as they roll down the runway.

Highway departments and municipalities have deployed systems to warn motorist of freezing conditions, but these tend to be area driven. If the condition being warned about is not present, area driven systems tend to “cry-wolf” one time too many, and de-sensitize drivers. As a result, they may come to ignore the warning, only to suffer worst consequences when conditions up ahead bring back freezing.

Active systems, such as those described in Leonhardt (U.S. Pat. No. 6,695,469), require a power source, and force the installation of extra infrastructure (e.g. back-up power sources). Lack of power may be mis-understood to be safe conditions, creating a potentially fatal condition.

There have been other systems indirectly taking advantage of freezing properties of water Mayer III (U.S. Pat. No. 6,302,054), but these do not have an innate indication of failure. If the indicator is down for either non-freezing conditions, or empty tank conditions, users may remain unaware of this condition until an accident occurs. The device described here is able to indicate when the level of fluid(s) is too low to operate.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

The invention takes advantage of a physical property of water when it approaches the freezing point. As water is cooled, it contracts, like other liquids do. However, when water is cooled below 4° C. (39° F.), unlike other liquids, water begins to expand. As the temperature moves from below 4° C. to 0° C., it continues to expand, until the freezing point (0° C. ) is reached. At that time, the liquid solidifies, and expansion stops. It has been found, that the spaces between the water molecules in ice are larger than the spaces between the water molecules in liquid water. As ice is formed, the need for increased space between the molecules causes the volume of the ice to be greater than that of the water from which it was formed. The volume of ice is greater than the volume of water from which the ice was formed, by approximately 9%. By necessity, this would increase the level of the remaining liquid in a container of fixed volume.

Since the freezing point of water can be reduced (that is brought below 0° C.) by the addition of solids or other liquids (such as alcohol) into water, the process described above might be tailored (reduced from occurring in the to 4° C. to 0° C. range, to say the 2° C. to −2° C. range) by changing the makeup of the consistency. This may be of interest in some situations, although in the majority of cases the 4° C. to 0° C. range would be adequate.

The aforesaid and other objectives are realized by providing a fluid container that is transparent at the top and may or may not be transparent at the bottom. One or more liquids are contained within, and preferably sealed from the elements, so that inadvertent addition of fluid(s) does not occur. The container itself may be mounted so that the transparent portion is on a high-visibility/contrast sign (such as a billboard), and the contrast between the background and the liquid itself could be enhanced by coloring the liquid visible fluid, or it may be a standalone device. As an alternative embodiment, a device or devices may be made to float on the liquid, increasing the visibility of the liquid level. A screen-like housing may be fitted around the complete container to protect it from vandalism and the like.

Water or other suitable expandable, freezable liquid is positioned in the fluid container that may be tubular or otherwise shaped. As the liquid freezes and expands, it is prevented from expanding by the structure of the container in any direction but “up”. As the liquid goes up, it's level in the visible portion of the container increases, moving the liquid (or any indicator floating on it), from the “normal” level, to the “Caution, Freezing” level. Motorists, pilots, or others passing by the indicator easily see the liquid level (or float in it) has moved into the warning zone and realize that at/near-freezing conditions now exist. As the weather condition changes and the temperature rises above freezing, the ice formed within the fluid container melts, the volume of liquid inside the container decreases, and this allows the level indicator to drop into the “Normal” or “Safe” level.

There have been other systems indirectly taking advantage of freezing properties of water Mayer III (U.S. Pat. No. 6,302,054), but systems such as these do not have an innate indication of failure (The indicator is down for either non-freezing conditions, or empty tank conditions). If through failure, or vandalism, the volume of liquid is reduced below the normal, the level of liquid displayed would fall below the indicated “normal” band, into a band that would easily allow maintenance crews (as well as motorists) to “call in” the defective indicator. This fail-safe mode increases the value of the display to users.

The present invention was conceived, and one of its objectives is, to provide an at/near freezing conditions indicator for motorists and others which is controlled by the actual weather conditions or temperature.

It is another objective of the present invention to provide a at/near freezing conditions indicator and method which can be readily placed in service along roads, highways, bridges, intersections and the like by relatively unskilled personnel.

It is still another objective of the present invention to provide an at/near freezing conditions indicator that is clearly visible by motorists and other passersby at a distance.

It is yet another objective of the present invention to provide an at/near freezing conditions indicator that can be constructed with no moving parts, can be easily maintained, and provides self-indications of malfunction.

It is another objective of the present invention to provide a compact, self-contained structure for providing a visual indication of at/near freezing conditions.

It is a further objective of the present invention to provide an at/near freezing conditions indicator that utilizes a fluid container which includes a liquid which expands during freezing.

It is a further objective of the present invention to provide a freezing indicator and method whereby the level of a fluid moves from a visible “Safe or Normal” position to a “Warning or Unsafe” position at/near freezing temperatures. In addition, the device will have a “Low Fluid(s), Inoperative” indication based on the level of fluid being too low at some ti me.

Other objects, features, and advantages of the present invention will become apparent upon examining the following detailed description of an embodiment thereof, taken in conjunction with the attached drawings.

### BRIEF DESCRIPTION OF THE DRAWINGS

FIG. 1 shows a side elevation view of the preferred embodiment of the at/near freezing conditions indicator, with the two principal levels zones (At/Near freezing above, Normal below), and the fail-safe indication level.

FIG. 2 shows the alternative embodiment of a single high-visibility floating object (or objects) floating on the surface of the liquid.

### DETAILED DESCRIPTION OF THE PREFERRED EMBODIMENT

In the following description, numerous specific details are set forth in order to provide a thorough understanding of the present invention. However, fit will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or an “embodiment” means that a particular feature structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the invention set forth herein will come to mind to one skilled in the art to which these inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Other objects, features, and advantages of the present invention will become apparent upon reading the following detailed description of the preferred embodiments of the invention when taken in conjunction with the drawings and the appended claims

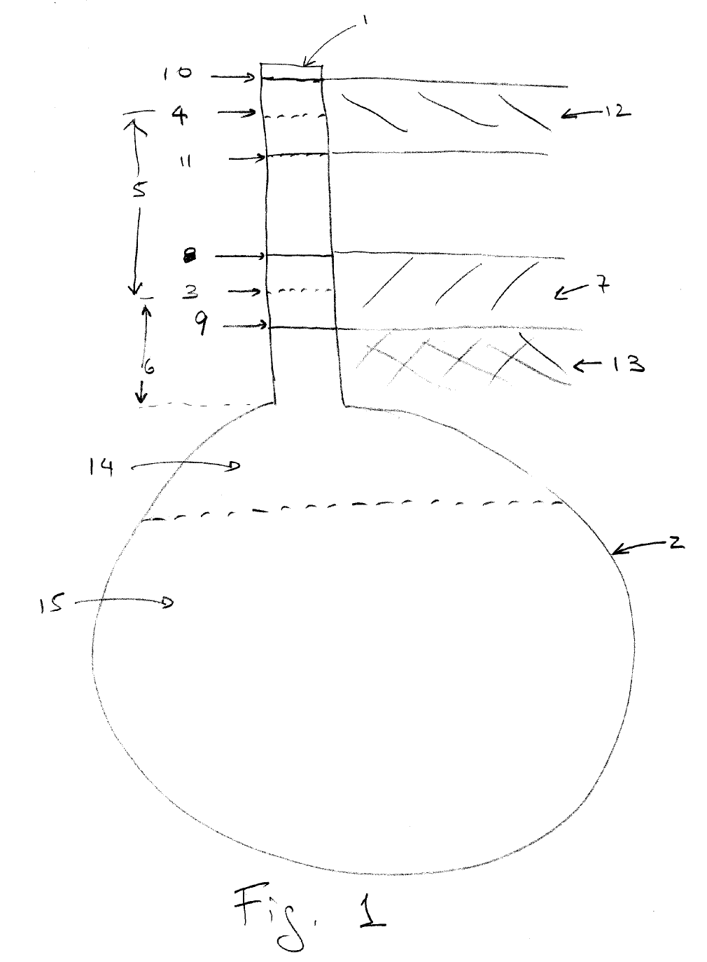

For a better understanding of the invention and its operation, turning now to the drawings, FIG. 1 shows the preferred embodiment of the at/near freezing condition indicator. The device consists of two portions, 1 is of necessity transparent, so that motorists and other may observe the level of the fluid inside. It is about one meter of height, and of any geometric shape, although a cylindrical shape might be preferred. It is approximately 100 mm in diameter. The reservoir, 2, does not have to be transparent (although being transparent may help the maintenance crew), and may be made of any material, as long as the freezing of the liquid inside does not change it's volumetric capacity (which would reduce the distance the liquid displaces up column 1).

While a device with a completely transparent vessel may be an embodiment, the pressures and environmental conditions may make a device made out of two materials preferable. As an example, the lower portion 1 may be made of metal (where visibility of the fluid is unnecessary), with the top portion 2 made of glass or plastic. One problem with such a construction would be the pressure exerted by water on the joint area between vessel materials. One envisioned solution would be embodiment of the device using water as the “lower” fluid 15, then using a fluid that is less dense than water (such as any oil) on the upper 14 portion. In this fashion, water would be contained within the sturdier metal vessel, and the lighter liquid would be contained in the visible portion.

The lower portion of the fluid(s) (again, in the preferred embodiment water, although this may be diluted with liquids [such as alcohol] or solids in an effort to lower the response temperature from 4° C. to perhaps 2 or 1° C.), will increase volume by between 8 and 9% when frozen, giving rise to the level in the column. For that reason, the distance between the level when the temperature is above the response level 3 and the level of warning 4 (at/near freezing) will be a function of the volume of 2 and that of 1. In this case, since we want a rise 5 of 600 mm on 1, the volume of this rise [(600*3.142*(50)**2)=4,713,000] would have to be equal to 9% of the volume in lower rise of the tube 6 [(200 mm*3.14*50**2)=1,571,000]. If 2 were a sphere, it would have a radius of approximately 250 mm (depending on the quality and quantity of the upper fluid). A sphere or teardrop is the preferred embodiment of 2, since this would provide the ice with an “easy out” up column 1.

Area 7 extends behind column 1 (in order to highlight the temperature indicator for easier identification at a distance) and is painted in a color schema that will magnify visibility with the (upper) fluid inside the column 14. It could additionally be marked (in the local language) to indicate that when the level of the liquid is within 8 and 9, conditions are safe (as far as at/near freezing temperatures, of course).

As the temperature drops below the design trigger point, the lower 15 liquid will begin to freeze and expand, bringing its level around 4. Levels 10 and 11 correspond to the levels the liquid would reach if it had begun at levels 8 and 9 respectively. This allows for the system to be operational even when the liquid level is not precisely maintained. As with area 7, area 12 extends behind 1 and is painted in a color schema that will magnify visibility against the fluid inside 1 (particularly at night or during low visibility conditions). One embodiment would be for the upper liquid 14 to be motor oil with black pigmentation, with area 12 being red.

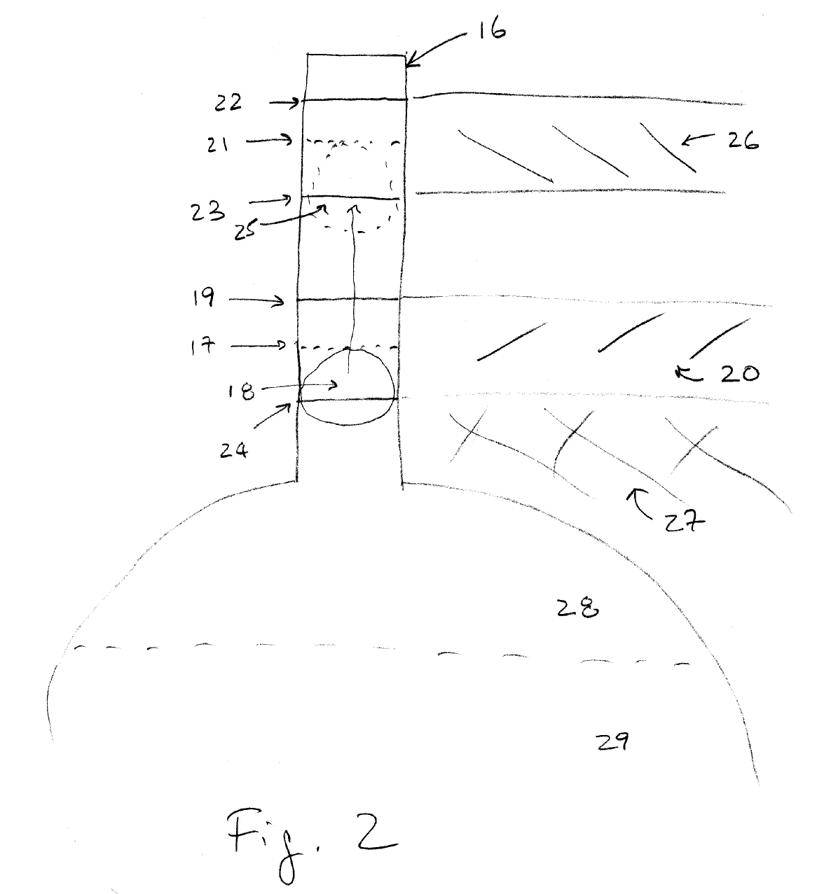

In an alternative embodiment, visibility of the liquid level may be improved by introducing a floating body (or bodies), such as a plastic ball, or balls, that could be colored orange for highest visibility inside 1. FIG. 2 illustrates this with a high visibility ball that moves from position 18 to position 25 as the upper fluid rises as result of the lower fluid expanding at/near freezing. Care would have to be exercised to ensure the inner surface of 1 is smooth enough so that this ball(s) does not get jammed into a position.

Over time, a fault condition may occur which could lead to a system failure. We refer to the event where the liquid level is allowed to drop below the normal operating range 9 and is not corrected by preventive maintenance. We have included area 13 as an optional indication of this condition. Located below level 9 (the lowest allowable level for normal operation), this area would include a warning (in the local language) and a request to call local maintenance if the level of the fluid is observed to reach no higher than it.

Conclusion

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

What is claimed is:

1. A device for indicating at/near freezing weather conditions comprising; a fluid container with a transparent portion; a fluid mix, said fluid mix contained within said fluid container; means for indicating that the liquid level reflects above freezing ambient temperature conditions, and that the frozen level indicates at/below freezing ambient temperatures conditions.

2. The device in claim 1 wherein said fluid mix comprises both water and another fluid of lower specific density.

3. The device in claim 1 where a floating object is placed within the fluid.

4. A method of indicating at/near freezing conditions utilizing a fluid mix, within a fluid container having a transparent portion, said method comprising the steps of: Allowing the fluid mix to be exposed to freezing conditions; Displaying externally to the fluid container that the liquid level reflects above freezing ambient temperature conditions, and the frozen level indicates at/near freezing ambient temperatures conditions.

5. The method of claim 4 wherein said fluid comprises both water and another fluid of lower specific density.

6. The method of claim 4 wherein a floating object is placed within the fluid.

7. The method of claim 4 further comprising the step of installing the container beside a road.
